(19) United States
(12) Patent Application Publication
(10) Pub. No.: US 2007/0138723 A1
(43) Pub. Date: Jun. 21, 2007

(54) Clamping device having replaceable clamping members

(76) Inventors: Chin Lin Hsu, Taichung City (TW); Mei Su Hsiao, Taichung City (TW)

Correspondence Address: BANGER SHIA, 204 CANYON CREEK, VICTORIA, TX, 77901-3695, US

(21) Appl. No.: 11/311,027

(22) Filed: Dec. 19, 2005

(51) Int. Cl. B23Q 3/02

(52) U.S. Cl. 269/96

(57) ABSTRACT

A clamping device includes two handles pivotally connected with each other and each having a first end and a second end, and two clamping members each detachably mounted on the first end of a respective one of the two handles by a quick release mechanism. Thus, the clamping members are detachably mounted on the handles by the quick release mechanism, so that the handles can co-operate with clamping members of different specifications and shapes according to different requirements, thereby facilitating a user operating the clamping device to clamp workpieces of different specifications and sizes.

### BACKGROUND OF THE INVENTION

1. Field of the Invention

The present invention relates to a clamping device, and more particularly to a clamping device having replaceable clamping members.

2. Description of the Related Art

A conventional clamping device comprises two opposite clamping members pivotally connected with each other and each having a first end and a second end. The two clamping members are pivotally connected with each other by a pivot shaft which is extended through a mediate portion of each of the two clamping members. The first ends of the two clamping members form a holding portion for holding an article, and the second ends of the two clamping members form a handle portion. An elastic member is mounted between the two clamping members to force the first ends of the two clamping members to move toward each other, so that the holding portion is closed at a normal state so as to clamp the article. However, the first ends of the two clamping members are easily forced to move away from each other by a foreign force or vibration to open the holding portion, so that the article is easily loosened from the holding portion. In addition, the clamping members are fixed and cannot be replaced, so that the clamping device cannot be used to clamp articles of different sizes, thereby causing inconvenience to the user.

A conventional clamping device having a braking mechanism is disclosed in the Taiwanese Patent Publication No. 386480 and 497527.

A conventional clamping device having a ratchet braking mechanism is disclosed in the Taiwanese Patent Publication No. 418767, 421119, 482070, 502684, and 512771.

Another conventional clamping device having a ratchet braking mechanism is disclosed in the U.S. Pat. Nos. D473,776, 6,240,815 and 6,550,738.

### SUMMARY OF THE INVENTION

The primary objective of the present invention is to provide a clamping device having clamping members that can be replaced arbitrarily according to different requirements.

Another objective of the present invention is to provide a clamping device, wherein the clamping members are detachably mounted on the handles by the quick release mechanism, so that the handles can co-operate with clamping members of different specifications and shapes according to different requirements, thereby facilitating a user operating the clamping device to clamp workpieces of different specifications and sizes.

A further objective of the present invention is to provide a clamping device, wherein the clamping members are mounted on and detached from the handles easily and rapidly, thereby facilitating the user replacing the clamping members.

In accordance with the present invention, there is provided a clamping device comprising two opposite handles pivotally connected with each other and each having a first end and a second end, and two clamping members each detachably mounted on the first end of a respective one of the two handles by a quick release mechanism.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a clamping device in accordance with the preferred embodiment of the present invention;

FIG. 2 is an exploded perspective view of the clamping device as shown in FIG. 1;

FIG. 3 is a partially plan cross-sectional view of the clamping device as shown in FIG. 1;

FIG. 4 is a partially plan cross-sectional view of a clamping device in accordance with another preferred embodiment of the present invention;

FIG. 5 is a partially exploded perspective view of a clamping device in accordance with another preferred embodiment of the present invention;

FIG. 6 is a partially exploded perspective view of a clamping device in accordance with another preferred embodiment of the present invention; and

FIG. 7 is a partially exploded perspective view of a clamping device in accordance with another preferred embodiment of the present invention.

### DETAILED DESCRIPTION OF THE INVENTION

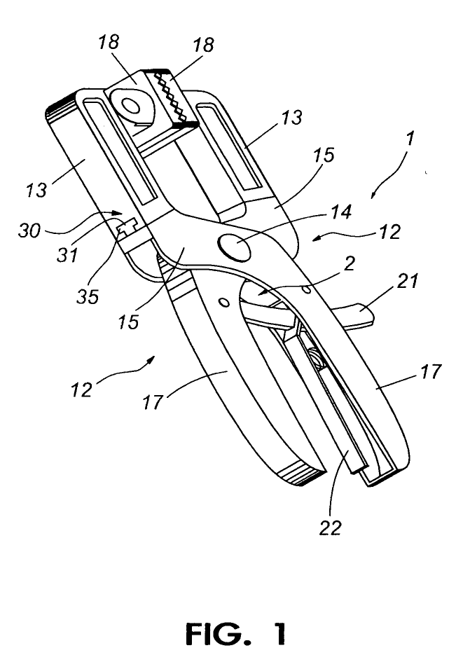

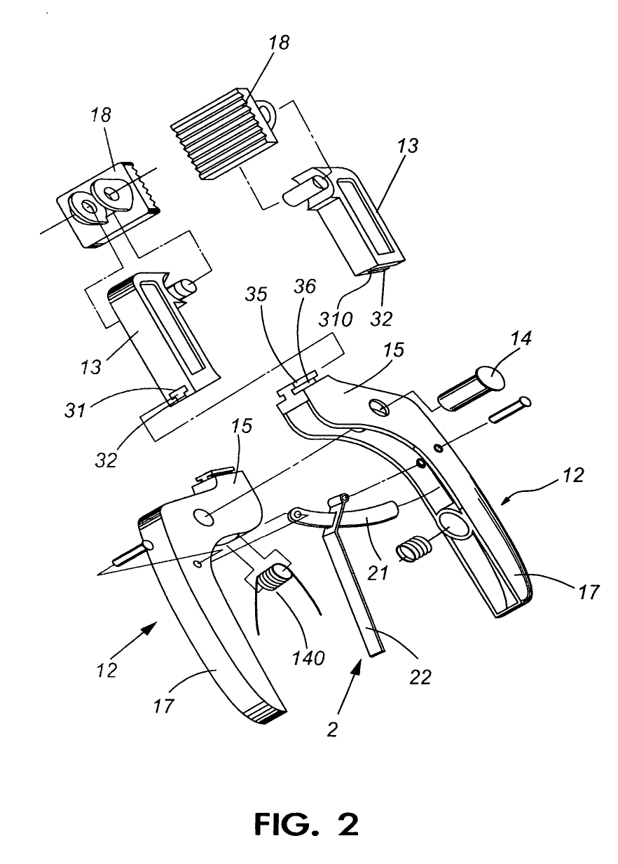

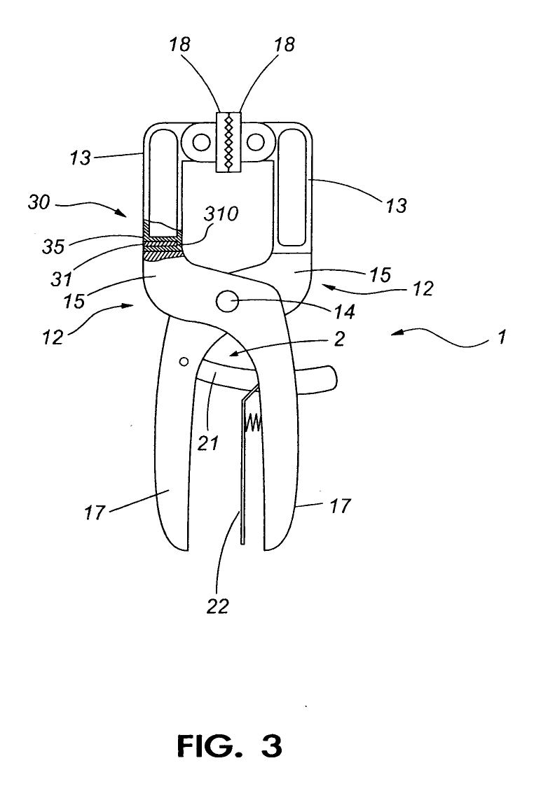

Referring to the drawings and initially to FIGS. 1-3, a clamping device 1 in accordance with the preferred embodiment of the present invention comprises two opposite handles 12 pivotally connected with each other and each having a first end 15 and a second end 17, two clamping members 13 each detachably mounted on the first end 15 of a respective one of the two handles 12 by a quick release mechanism 30, and a braking mechanism 2 mounted between the second ends 17 of the two handles 12 to provide a stepless braking effect to the two handles 12.

The two handles 12 are pivotally connected with each other by a pivot shaft 14 which is extended through a mediate portion of each of the two handles 12. The pivot shaft 14 is located between the first end 15 and the second end 17 of each of the two handles 12 and located adjacent to the first end 15 of each of the two handles 12. A torsion spring 140 is mounted on the pivot shaft 14 and has two ends each urged on an inner side of the second end 17 of the respective handle 12 to open the two handles 12 so that the two handles 12 are opened at a normal state.

Each of the two clamping members 13 has a distal end provided with a serrated protective member 18 to hold a workpiece (not shown) located between the two clamping members 13.

The braking mechanism 2 includes a braking member 22 pivotally mounted on a first one of the two handles 12, and a locking member 21 having a first end pivotally mounted on a second one of the two handles 12 and a second end extended through the braking member 22 and the first one of the two handles 12 to provide a stepless braking effect to the two handles 12.

The quick release mechanism 30 is mounted between the two clamping members 13 and the first ends 15 of the two handles 12 and located adjacent to the pivot shaft 14. The quick release mechanism 30 includes an insertion recess 31 and an insertion block 35 detachably inserted into the insertion recess 31. The insertion block 35 of the quick release mechanism 30 has a cross-sectional profile corresponding to that of the insertion recess 31. The insertion recess 31 of the quick release mechanism 30 has a side formed with a passage 32, and the insertion block 35 of the quick release mechanism 30 has a side formed with a neck portion 36 detachably inserted into the passage 32 of the insertion recess 31. The passage 32 of the quick release mechanism 30 has a width smaller than that of the insertion recess 31, and the neck portion 36 of the quick release mechanism 30 has a width smaller than that of the insertion block 35. The insertion recess 31 and the passage 32 of the quick release mechanism 30 form a substantially T-shaped cross-sectional profile, and the insertion block 35 and the neck portion 36 of the quick release mechanism 30 form a substantially T-shaped cross-sectional profile.

In the preferred embodiment of the present invention, the insertion recess 31 of the quick release mechanism 30 is formed in each of the two clamping members 13 and extended in a direction parallel with a moving direction of each of the two clamping members 13, and the insertion block 35 of the quick release mechanism 30 is formed on the first end 15 of each of the two handles 12 and extended in a direction parallel with a moving direction of each of the two handles 12. The insertion recess 31 of the quick release mechanism 30 is not extended through a whole width of each of the two clamping members 13 and has an inner side formed with a closed wall 310 to stop the insertion block 35. The passage 32 of the quick release mechanism 30 is extended through an end face of each of the two clamping members 13.

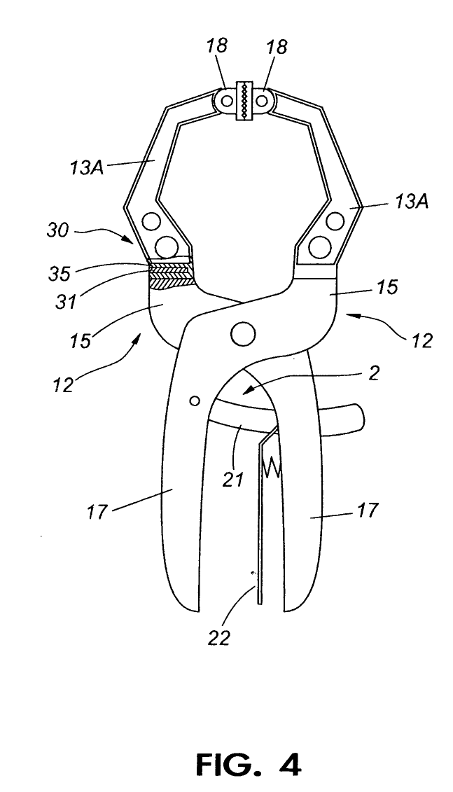

Referring to FIG. 4, two different clamping members 13A are detachably mounted on the first ends 15 of the two handles 12 by the quick release mechanism 30, so that the clamping device comprises two clamping members that can be replaced arbitrarily according to different requirements.

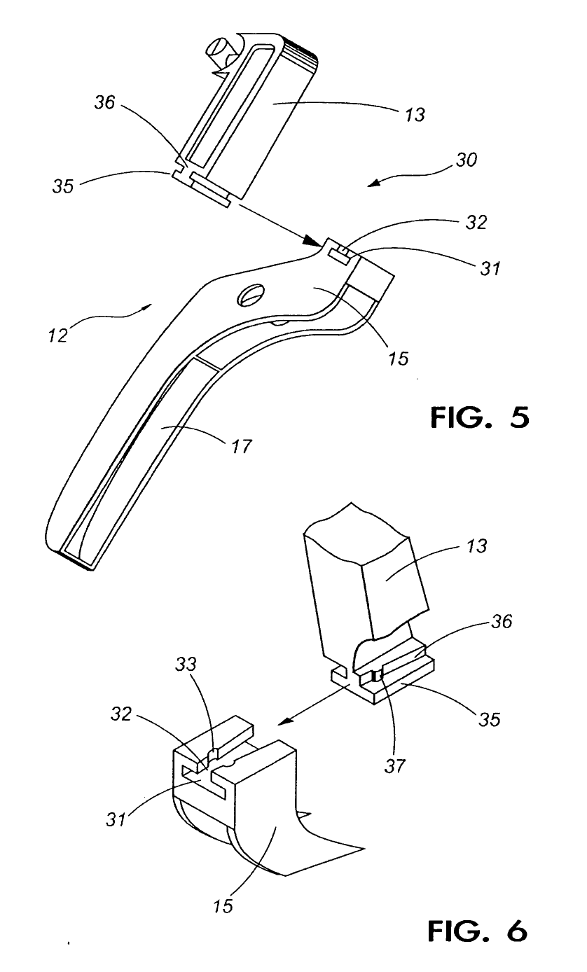

Referring to FIG. 5, the insertion recess 31 of the quick release mechanism 30 is formed in the first end 15 of each of the two handles 12 and extended in a direction perpendicular to the moving direction of each of the two handles 12, and the insertion block 35 of the quick release mechanism 30 is formed on each of the two clamping members 13 and extended in a direction perpendicular to the moving direction of each of the two clamping members 13. The insertion recess 31 of the quick release mechanism 30 is extended through a whole width of each of the two handles 12. The passage 32 of the quick release mechanism 30 is extended through an end face of each of the two handles 12.

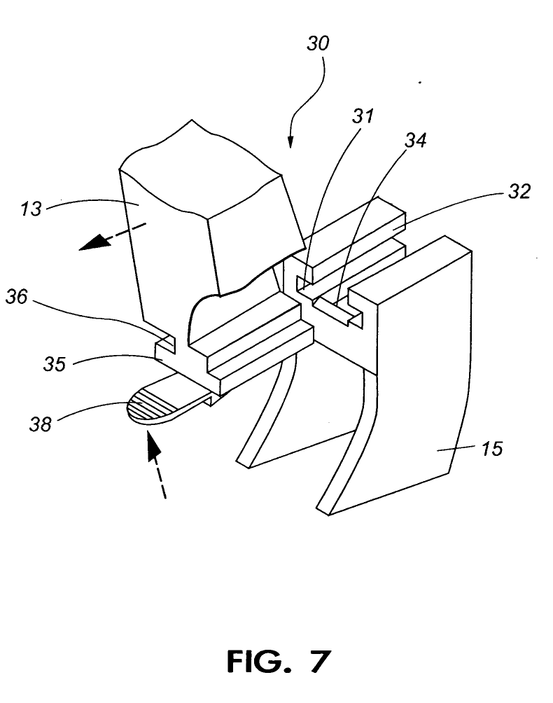

Referring to FIG. 6, the passage 32 has a tapered shape, and the neck portion 36 has a tapered shape corresponding to that of the passage 32. In addition, the passage 32 has two opposite sides each formed with a positioning groove 33, and the neck portion 36 has two opposite sides each formed with a positioning boss 37 detachably positioned in the respective positioning groove 33 of the passage 32.

Referring to FIG. 7, the insertion recess 31 of the quick release mechanism 30 has a bottom face provided with a locking block 34, and the insertion block 35 of the quick release mechanism 30 has a bottom face provided with an elastic locking block 38 detachably snapped onto the locking block 34.

Accordingly, the clamping members are detachably mounted on the handles by the quick release mechanism, so that the handles can co-operate with clamping members of different specifications and shapes according to different requirements, thereby facilitating a user operating the clamping device to clamp workpieces of different specifications and sizes. In addition, the clamping members are mounted on and detached from the handles easily and rapidly, thereby facilitating the user replacing the clamping members.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A clamping device, comprising:
two opposite handles pivotally connected with each other and each having a first end and a second end;
two clamping members each detachably mounted on the first end of a respective one of the two handles by a quick release mechanism.

2. The clamping device in accordance with claim 1, wherein the quick release mechanism includes an insertion recess and an insertion block detachably inserted into the insertion recess.

3. The clamping device in accordance with claim 2, wherein the insertion block of the quick release mechanism has a cross-sectional profile corresponding to that of the insertion recess.

4. The clamping device in accordance with claim 2, wherein the insertion recess of the quick release mechanism has a side formed with a passage, and the insertion block of the quick release mechanism has a side formed with a neck portion detachably inserted into the passage of the insertion recess.

5. The clamping device in accordance with claim 4, wherein the passage of the quick release mechanism has a width smaller than that of the insertion recess, and the neck portion of the quick release mechanism has a width smaller than that of the insertion block.

6. The clamping device in accordance with claim 4, wherein the insertion recess and the passage of the quick release mechanism form a substantially T-shaped cross-sectional profile, and the insertion block and the neck portion of the quick release mechanism form a substantially T-shaped cross-sectional profile.

7. The clamping device in accordance with claim 1, wherein the two handles are pivotally connected with each other by a pivot shaft which is extended through a mediate portion of each of the two handles.

8. The clamping device in accordance with claim 7, wherein the pivot shaft is located between the first end and the second end of each of the two handles and located adjacent to the first end of each of the two handles.

9. The clamping device in accordance with claim 7, wherein the quick release mechanism is mounted between the two clamping members and the first ends of the two handles and located adjacent to the pivot shaft.

10. The clamping device in accordance with claim 4, wherein the insertion recess of the quick release mechanism is formed in each of the two clamping members, and the insertion block of the quick release mechanism is formed on the first end of each of the two handles.

11. The clamping device in accordance with claim 10, wherein the insertion recess of the quick release mechanism is extended in a direction parallel with a moving direction of each of the two clamping members, and the insertion block of the quick release mechanism is extended in a direction parallel with a moving direction of each of the two handles.

12. The clamping device in accordance with claim 10, wherein the insertion recess of the quick release mechanism is not extended through a whole width of each of the two clamping members and has an inner side formed with a closed wall to stop the insertion block.

13. The clamping device in accordance with claim 10, wherein the passage of the quick release mechanism is extended through an end face of each of the two clamping members.

14. The clamping device in accordance with claim 4, wherein the insertion recess of the quick release mechanism is formed in the first end of each of the two handles, and the insertion block of the quick release mechanism is formed on each of the two clamping members.

15. The clamping device in accordance with claim 14, wherein the insertion recess of the quick release mechanism is extended in a direction perpendicular to a moving direction of each of the two handles, and the insertion block of the quick release mechanism is extended in a direction perpendicular to a moving direction of each of the two clamping members.

16. The clamping device in accordance with claim 14, wherein the insertion recess of the quick release mechanism is extended through a whole width of each of the two handles.

17. The clamping device in accordance with claim 14, wherein the passage of the quick release mechanism is extended through an end face of each of the two handles.

18. The clamping device in accordance with claim 4, wherein the passage has a tapered shape, and the neck portion has a tapered shape corresponding to that of the passage.

19. The clamping device in accordance with claim 4, wherein the passage has two opposite sides each formed with a positioning groove, and the neck portion has two opposite sides each formed with a positioning boss detachably positioned in the respective positioning groove of the passage.

20. The clamping device in accordance with claim 2, wherein the insertion recess of the quick release mechanism has a bottom face provided with a locking block, and the insertion block of the quick release mechanism has a bottom face provided with an elastic locking block detachably snapped onto the locking block.
